(19) United States
(12) Patent Application Publication
(10) Pub. No.: US 2003/0229495 A1
(43) Pub. Date: Dec. 11, 2003

(54) Microphone array with time-frequency source discrimination

(75) Inventors: Lars C. Almstrand, San Diego, CA (US); Courtney Konopka, Carlsbad, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ

(21) Appl. No.: 10/457,153

(22) Filed: Jun. 9, 2003

Related U.S. Application Data
(60) Provisional application No. 60/388,123, filed on Jun. 11, 2002.

(51) Int. Cl. G10L 15/00

(52) U.S. Cl. 704/255

(57) ABSTRACT

A 3D microphone array is provided for, e.g., sending sound to a speech recognition (SR) engine. To increase SNR while minimizing the computational load on the SR engine, the array processor compares received time-frequency profiles from various sources of sound to a model hypothesis provided by the SR engine, and sends on to the SR engine only those profiles that are similar to the model hypothesis. If desired, sources of sound can also be discriminated against on the basis of energy level and spatial location within a room.

### I. FIELD OF THE INVENTION

The present invention relates generally to microphone arrays.

### II. BACKGROUND OF THE INVENTION

Speech recognition devices are well-known. They are used primarily for applications such as word processing, wherein a person speaks into a microphone and acoustic sub-words (parts of speech) are recognized by their acoustic patterns and then converted to binary representations and combined into words. In this way, speech can be directly converted into an electronic text file.

For speech recognition devices to work best, the acoustic signals that are processed must have a fairly high signal-to-noise ratio (SNR). The SNR of speech spoken directly into a microphone that is held in front of the speaker's mouth is relatively high, to suit this requirement. On the other hand, the SNR of acoustic signals received on, e.g., an open microphone or speakerphone that is located, for instance, on a table in the middle of a room is generally lower. Consequently, while such microphones are convenient from the standpoint of allowing a person to roam about a room while talking and doing other tasks, the present invention recognizes that to use such microphones as input devices for speech recognition engines, the SNR must be augmented over what might otherwise be afforded.

As understood herein, a microphone array (i.e., several microphones arranged in an array and coupled to a central microphone processor) can be used as a speaker phone, with array microphones providing a directional capability such that the array processor can “form a beam” (i.e., focus) on sound from specific directions while ignoring sound from other directions. In this way, the SNR of the sound that is processed advantageously is increased.

The present invention further understands, however, that beamforming itself can be processor-intensive. Moreover, it is recognized herein that many sources of sound can be present in a room, which would require many beams to be formed and thus require the speech recognition engine to discriminate the sought-after beam from the various other beams that are received from the microphone array. Accordingly, the present invention provides the solutions disclosed herein.

### SUMMARY OF THE INVENTION

A microphone array system includes plural microphones and an array processor that receives signals from the microphones. The array processor executes logic which includes receiving a model time-frequency acoustic hypothesis. Based on the model time-frequency acoustic hypothesis, the array processor selectively outputs signals that represent acoustic sources to a client component, such as but not limited to a speech recognition engine.

In a preferred embodiment, the logic executed by the array processor can include selectively outputting signals to the client component based on acoustic energy levels received from the acoustic sources. Moreover, the logic executed by the array processor may further include selectively outputting signals to the client component based on whether the sources are in a predetermined space. A buffer can be provided to store signals while the array processor executes the logic, with data in the buffer being selectively sent to the client component.

When the client component is a speech recognition device, it can include a feature extraction component that receives signals from the array processor and that sends signals to the speech recognition engine. In this exemplary embodiment, the model time-frequency acoustic hypothesis is generated by sending a signal from the speech recognition engine to the feature extraction component and generating the hypothesis at the feature extraction component, prior to providing a time-frequency representation of the hypothesis to the array processor. As set forth further below, the model hypothesis may represent at least one acoustic temporal pattern such as an acoustic sub-word.

In another aspect, a method for alleviating processing load on a speech recognition system by screening signals from acoustic sources in a space includes comparing at least one signal from at least one acoustic source in the space to at least one acoustic model. Based at least in part on the comparing act, the signal is selectively sent to the speech recognition system.

In yet another aspect, a device is disclosed that embodies means for processing acoustic signals received from acoustic sources in a volume. The device includes means for comparing signals from sources in the volume to a predefined time-frequency hypothesis. Means send signals to the speech recognition system, responsive to the means for comparing.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of a space in which the present microphone array is disposed, showing schematic representations of acoustic signals from various sources;

FIG. 2 is a schematic diagram of one preferred architecture; and

FIG. 3 is a logic flow chart of the present invention.

### DETAILED DESCRIPTION OF THE PREFERRED EMBODIMENT

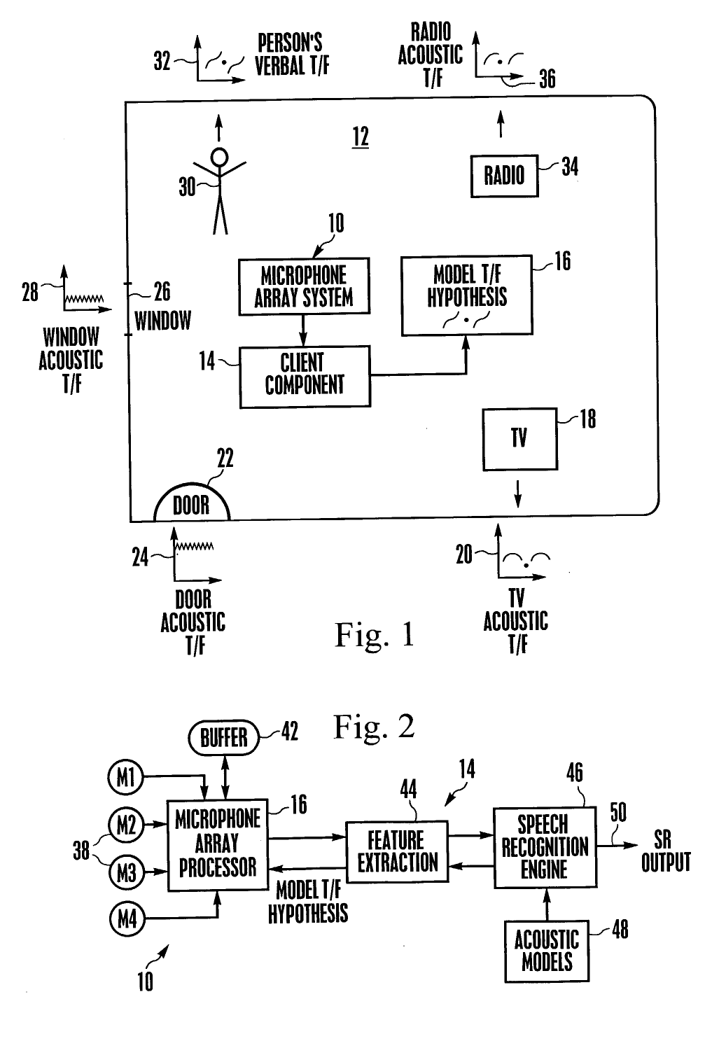

Referring initially to FIG. 1, a microphone array is shown, generally designated 10, that can receive sound from a space 12 and output electrical signals representing the sound to a client component 14. In preferred, non-limiting embodiments the array 10 is a three dimensional array and the client component 14 includes a speech recognition (SR) device, such as speech recognition software with prescreening components described below, that can provide one or model hypotheses (designated at 16) to the array 10. In the preferred, non-limiting embodiment, the model hypothesis 16 is a time (on the x-axis)-frequency (on the y-axis) Cartesian profile, although other types of hypotheses, including energy profiles, can be used. It is to be understood that instead of being a three-dimensional array (i.e., an array with at least four microphones, any three of which establish a plane and the fourth being distanced from the plane), the array 10 can also be a two-dimensional array. It is to be further understood that client components other than SR devices can be used, e.g., the client component 14 might be a sound speaker that is to play only predetermined sounds, e.g., bird chirps, that conform to the model hypothesis 16.

In the non-limiting illustrative environment shown in FIG. 1, various sources of sound are shown in the space 12, along with graphic representations of the sound they emit. Beginning in the lower right corner, a TV 18 might produce sound at least a portion of which establishes a time-frequency (T/F) profile 20 that, as shown, includes upside-down semicircles separated by a dot. Also, sound can emanate from a door 22 that has an acoustic energy profile 24, and from a window 26 that has, as shown at 28, a relatively lower acoustic energy profile than the door 22.

Also, a person 30 might be speaking in the room, with at least a portion of the speech establishing a T/F profile 32 that closely resembles the model hypothesis shown at 16. Finally, a radio 34 can play sound having at least in part a T/F profile 36 that, like the exemplary model hypothesis shown, is characterized by two curves that extend up and to the right and that are separated by a dot, but one that, unlike the model hypothesis shown for illustration, is not characterized by a dogleg in each curve.

One exemplary, non-limiting architecture is shown in FIG. 2. As shown, the array 10 can include plural microphones 38 that receive acoustic energy and output electrical signals representative thereof to an array processor system 40. The processor system 40 can include a digital processor proper as well as necessary digitizing components known in the art.

The processor 40 can further access a data buffer 42 to store digitized signals in the buffer 42 pending the results of the logic disclosed below, prior to sending the signals on to the client component 14. In the preferred embodiment shown in FIG. 2, the client component 14 can be a speech recognition (SR) device that includes a feature extraction component 44 for extracting key features of signals received from the array processor 40, a speech recognition engine 46 that receives the output of the feature extraction component 44, and acoustic models 48 that are used by the SR engine 46 in accordance with means known in the art to transform electrical signals representing sound into electronic text (or other) tokens for output thereof as indicated at 50. As also shown, the model T/F hypotheses mentioned above and discussed further below can be sent from the SR engine 46 by way of the feature extraction component 44 to the array processor 40. The SR engine 46 may access a spelling dictionary and hidden Markov models in accordance with SR operating principles known in the art.

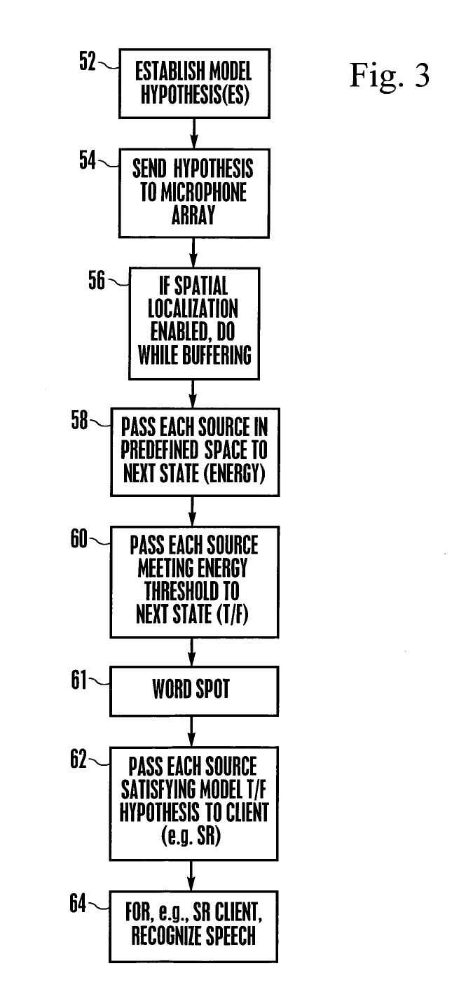

The logic of the array processor 40 can be seen in reference to FIG. 3, it being understood that the below-described logic may be executed in whole or in part by the client component 14 if desired. Commencing at block 52, the model hypothesis is established. In one preferred, non-limiting embodiment, the model hypothesis might represent a predetermined acoustic temporal pattern such as an acoustic sub-word or series of sub-words, such as a signalling word like “Mona” that can be programmed into a word spotter implemented as a standalone component or integrated component in the processor 40 or outside of the processor 40. To establish the model, the SR engine 46 can cooperate with the feature extraction component 44 to transform electronic symbols representative of, e.g., “Mona”, to the T/F graph shown in the model hypothesis box 16 of FIG. 1, essentially by reverse SR. Or, the model hypothesis can be any other T/F graph as desired by the user, e.g., a graph representing bird chirps. At block 54, the model hypothesis is sent to the array processor 40/word spotter.

Block 56 indicates that if desired, spatial localization can be enabled and used to pre-screen sounds received by the array 10. Specifically, since the array 10 is a multi-dimensional array, a predetermined space from which sounds will be subsequently processed can be defined during a calibration process, with sounds emanating from locations outside the predetermined space being attenuated during subsequent processing. The predetermined space can be defined by means well known in the art, e.g., by using geometric triangulation to correlate differences among the microphones 38 in the times of reception of a sound wave to the spatial boundaries of the desired volume. Thus, for instance, the boundaries of the entire space 12 shown in FIG. 1 can be predetermined to be the space of consideration, with sound emanating from points outside the space 12 being attenuated, or only a portion of the space 12 might be predetermined to be the space of interest, with sounds emanating from outside the portion being disregarded.

To define the space, a calibration process can be used. As one non-limiting example, a beeper that transmits a sine wave can be located at various points along the desired boundary of the space and activated, with the system being set in a calibration mode such that the system receives the beeps, triangulates the position of the source beeper to find the position, and then stores the positions as a map of the space boundary. Moreover, when a known sine wave is used, any distortions, amplifications, or attenuations can be noted from the various locations and either the user informed not to stand at distorting locations or the system adjusted as appropriate to cancel out the distortions, e.g., by amplifying all subsequent sounds from a location at which the beeper signal experienced attenuation during calibration.

As indicated at block 56, for sounds emanating from inside the predetermined space of interest, such sounds are temporarily buffered while being passed to the next state of the logic at block 58. This is an optional state that further pre-screens sounds on the basis of energy level, with signals exhibiting acceptable levels being passed to the T/F discrimination state at block 60. To illustrate, the relatively low energy level sounds (represented by the graph 28 in FIG. 1) from the window 26 might be screened out from further processing at this point in the logic, whereas higher-level sounds such as that of the door graph 24, person profile 32, TV profile 20, and radio profile 36 might be passed on.

If desired, sounds that pass the logic at blocks 58 and 60 can be sent to a word spotter that is programmed to recognize just a few unique signalling words (such as “Mona”) and which functions in accordance with principles known in the art to pass on any candidate signalling words to the speech recognition engine, such that the system can focus on the location of the source of the signalling word. The user can update the signalling words used by the word spotter. Or, dynamic time warping (DTW) can be used at block 61 to modify a received signal to match a hypothesis entry.

At block 62 the sound profiles that have satisfied the above spatial prescreening conditions (if enabled), the energy level pre-screening conditions (if enabled), and word spotting/DTW conditions (if enabled) are compared to the model hypothes(es). Only sounds bearing a T/F profile that is sufficiently similar to the model hypothes(es) are passed, at block 62, from the buffer 42 to the client component 14 (which can include, e.g., the SR system shown in FIG. 2) for, e.g., speech recognition of the signals at block 64. The comparison between the signal curves from the various sources and the curve(s) of the model hypothes(es) can be made in accordance with signal comparison principles known in the art, e.g., it can be based on a least-squares fit, point by point, or on some other signal comparison paradigm.

Again using the example profiles in FIG. 1, at block 62 the TV profile 20 and door profile 24 might be filtered out and not passed on to the client component 14. In contrast, the person profile 32 and radio profile 36 might both exhibit sufficient resemblance to the model hypothesis to warrant sending signals from these sources on to the client component 14. It will be readily appreciated that by eliminating one or more sources of sound in this way, the array processor 40 relieves the client component 14 of significant processing load.

What constitutes sufficient similarity between a source T/F profile and the model hypothes(es) varies from application to application, and can be done by raw curve analysis that accounts for the processing capability of the client component 14. Essentially, the risk of losing what might be valuable data is balanced on an application-by-application basis against the increased performance afforded to the particular client component 14 by the above-described pre-discrimination of signals, to establish what constitutes sufficient similarity.

With the above disclosure in mind, it may now be appreciated that the present invention provides a multidimensional microphone array that is tightly coupled to its client component and that can pre-screen acoustic sources in parallel with the processing being undertaken by the client component. Moreover, it may now be appreciated that the array 10 described herein is dynamic, in that the model hypothes(es) can be changed as desired to change what T/F profiles are passed on to, e.g., the SR engine 46 shown in FIG. 2.

It is to be understood that while for convenience the above logic is described in terms of logical states such as might be assumed by a state machine, the logic can also be thought of as a series of decision steps, wherein the logic flows from one decision step to the next when certain conditions test positive, e.g., spatial location, energy level, and finally T/F profile similarity.

The logic may be executed by a processor or processors within the present system as a series of computer-executable instructions. The instructions may be contained on a data storage device with a computer readable medium, such as a computer diskette having a computer usable medium with code elements stored thereon. Or, the instructions may be stored on random access memory (RAM) of the computer, or on conventional hard disk drive, electronic read-only memory, optical storage device, or other appropriate data storage device.

Indeed, the flow charts herein illustrate the structure of the logic of the present invention as might be embodied in computer program software. Those skilled in the art will appreciate that the flow charts illustrate the structures of computer program code elements that may function according to this invention. Manifestly, the invention can be practiced in its essential embodiment by a machine component that renders the program code elements in a form that instructs a digital processing apparatus (that is, a computer) to perform a sequence of function steps corresponding to those shown.

While the particular MICROPHONE ARRAY WITH TIME-FREQUENCY SOURCE DISCRIMINATION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”.

WE CLAIM:

What is claimed is:

1. A microphone array system, comprising:
plural microphones; and
at least one array processor receiving signals from the microphones, the array processor executing logic including:
receiving at least one model time-frequency acoustic hypothesis; and
based at least in part on the model time-frequency acoustic hypothesis, selectively outputting signals representing at least one acoustic source to at least one client component.

2. The system of claim 1, wherein the client component includes at least one speech recognition engine, and the system further comprises the engine.

3. The system of claim 1, comprising at least four microphones establishing a three dimensional array.

4. The system of claim 1, wherein the logic executed by the array processor further includes selectively outputting signals to the client component based at least in part on at least one acoustic energy level received from at least one acoustic source.

5. The system of claim 1, wherein the logic executed by the array processor further includes selectively outputting signals to the client component based at least in part on at least one spatial location of at least one acoustic source.

6. The system of claim 1, further comprising at least one buffer storing signals while the array processor executes the logic, data in the buffer being selectively sent to the client component.

7. The system of claim 2, further comprising at least one feature extraction component receiving signals from the array processor and sending signals to the speech recognition engine.

8. The system of claim 7, wherein the model time-frequency acoustic hypothesis is generated by sending at least one signal from the speech recognition engine to the feature extraction component and generating a time-frequency representation of the hypothesis at the feature extraction component, prior to providing the hypothesis to the array processor.

9. The system of claim 8, wherein the hypothesis represents at least one acoustic temporal pattern.

10. The system of claim 1, wherein the hypothesis represents at least one acoustic temporal pattern.

11. The system of claim 1, further comprising the client component, wherein the client component includes at least one audio speaker.

12. A method for alleviating processing load on a speech recognition system by screening signals from acoustic sources in a space, comprising:
comparing at least one signal from at least one acoustic source in the space to at least one acoustic model; and
based at least in part on the comparing act, selectively sending the signal to the speech recognition system.

13. The method of claim 12, wherein the acoustic model is at least one time-frequency hypothesis.

14. The method of claim 12, wherein the acoustic model is at least one acoustic energy level.

15. The method of claim 12, wherein the space is predefined, and the acoustic model is at least whether a source is located in the space.

16. The method of claim 12, comprising receiving signals from acoustic sources at a multidimensional microphone array and undertaking the comparing and sending acts at the array.

17. The method of claim 16, wherein the array is a three dimensional array.

18. The method of claim 13, wherein the time-frequency hypothesis is received by the array from the speech recognition system.

19. A device embodying means for processing acoustic signals received from at least one source in at least one volume, comprising:
means for comparing signals from sources in the volume to at least one time-frequency hypothesis; and
means, responsive to the means for comparing, for sending signals to the speech recognition system.

20. The device of claim 19, further comprising:
means for defining the volume; and
means for invoking the comparing means only in response to acoustic signals received from sources within the volume.

21. The device of claim 19, further comprising:
means for invoking the comparing means only in response to acoustic signals having at least a predetermined energy.

22. The device of claim 19, further comprising the speech recognition system.

23. The device of claim 22, wherein the speech recognition system comprises means for defining the time-frequency hypothesis.

24. The device of claim 19, wherein the means for comparing is executed by a three dimensional microphone array processor.

25. The device of claim 19, wherein the means for comparing and sending are embodied in software.

26. The device of claim 19, wherein the means for comparing and sending are embodied in hardware.
